(19) United States
(12) Patent Application Publication
(10) Pub. No.: US 2004/0074148 A1
(43) Pub. Date: Apr. 22, 2004

(54) Opening and closing system for power sliding door

(76) Inventor: Jun Moo Her, GWANGMYEONG-SHI (KR)

Correspondence Address: MORGAN, LEWIS & BOCKIUS, LLP., 3300 HILLVIEW AVENUE, PALO ALTO, CA, 94304, US

(21) Appl. No.: 10/665,588

(22) Filed: Sep. 19, 2003

(30) Foreign Application Priority Data
Oct. 2, 2002 (KR) 2002-67640

(51) Int. Cl. E05F 11/00

(52) U.S. Cl. 49/324

(57) ABSTRACT

The invention relates to an opening and closing system for a power sliding door, which has a locking controller, a sensor, a driving device, and an ECU. The locking controller transfers driving force of a handle to a door-closed state keeping unit or a door-open state keeping unit in order to control operation. The opening and closing system for the sliding door may be installed in a vehicle equipped with a sliding door having a door-open state keeping unit and allows safe operation of the vehicle and door.

### CROSS-REFERENCE TO RELATED APPLICATIONS

This application claims priority of Korean Application No. 2002-67640, filed on Nov. 2, 2002, the disclosure of which is incorporated fully herein by reference.

### FIELD OF THE INVENTION

The present invention relates to an opening and closing system for power sliding doors in vehicles.

### BACKGROUND OF THE INVENTION

As generally known in the art, a sliding door installed in a vehicle, such as a van, is opened or closed by slidably moving to the front and rear directions of the vehicle along a lateral side of the vehicle body. In this manner the sliding door can be easily opened or closed without interference with peripheral structures, even if the vehicle is parked in a narrow place, and passengers can easily enter into the vehicle.

A conventional sliding door includes a door-closed state keeping unit, a locking controller connected to the door-closed state keeping unit to control operation of the door-closed state keeping unit, inner and outer handle assemblies connected to the locking controller to release a door-closed state, and a door locking knob connected to the locking controller to control the locking controller in such a manner that the sliding door is locked in the door-closed state.

When the sliding door is closed, the door-closed state keeping unit automatically fixes the sliding door so that the sliding door is maintained in the door-closed state. The door-closed state can be released by operating the inner and outer handle assemblies. On the other hand, the door-locking knob locks the sliding door in the door-closed state, so that the sliding door is not opened even if a person operates the inner and outer handle assemblies.

However, the conventional sliding door system has a problem in that if a person opens the conventional sliding door when the vehicle is parked on an inclined road, the sliding door is biased in the door-close direction due to the incline. Thus, passengers who try to enter into the vehicle may be injured by the sliding door moving in the door-close direction.

To solve the above problem, there has been suggested a door-open state keeping unit installed in the sliding door for maintaining the sliding door in a door-open state. Door-open state keeping units have been widely used and various kinds of locking controllers and inner and outer handles have been developed to control operation of a door-open state keeping unit

For example, Korean Patent Laid-open Gazette No. 2002-37464 discloses an opening and closing system for a sliding door having a door-open state keeping unit.

Power sliding doors, which are automatically opened/closed by means of a wire/wireless door switch, have been installed in vehicles, such as vans, equipped with a sliding door. The power sliding door is automatically opened/closed by using a driving source including motors and cylinders and a power transmission including cables, belts and gears. An ECU (electrical control unit) is also provided to control an operation of the driving source in cooperation with the door switch.

However, the above sliding door opening/closing system or various door opening/closing systems having the door-open state keeping unit basically open or close the door through manual operation of the handle assembly.

Therefore, the power sliding door is rarely adapted for the conventional sliding door opening/closing systems. For this reason, it has become necessary to provide an opening/closing system for a power sliding door capable of allowing operation of a power sliding door in both manual mode, using a handle, and a power mode, using a door switch

### SUMMARY OF THE INVENTION

Embodiments of the present invention provide an opening and closing system for a power sliding door adapted for a vehicle equipped with a sliding door having a door-open state keeping unit, in which the door-open state keeping unit cooperats with a door switch in such a manner that the power sliding door is normally opened or closed even if a user only operates the door switch.

In one preferred embodiment, there is provided an opening and closing system for a power sliding door comprising: a locking controller including a plurality of links installed in a housing, transferring driving force of a handle to a door-closed state keeping unit or a door-open state keeping unit in order to control an operation of the door-closed state keeping unit or door-open state keeping unit, and having a link for locking or releasing the door-open state keeping unit through a cable; a means for detecting locking and releasing states of the door-open state keeping unit; a driving means for switching the door-open state keeping unit into the locking state or the releasing state by operating the link; and an ECU controlling a driving source, which opens or closes the sliding door, by receiving a signal from a door switch and controlling an operation of the driving means by receiving a detecting signal regarding the locking state and the releasing state of the door-open state keeping unit from the detecting means.

According to a preferred embodiment of the present invention, the link is rotatably fixed to the housing about a hinge shaft and connected to the door-open state keeping unit through a cable, and the driving means is connected to one end of the link so as to rotate the link about the hinge shaft.

Preferably, the driving means includes an actuator having a driving end formed with an elongated hole, into which a free end of the link is movably inserted

More preferably, the door-open state keeping unit includes a coupling link rotatably coupled with a protrusion of a chassis member, and a locking link rotatably connected to the link through the cable in order to lock or release a coupling state between the coupling link and the protrusion, and the detecting means detects the locking and releasing states of the door-open state keeping unit depending on a rotational position of the locking link.

The detecting means may include a micro-switch, which is installed at one side of the locking link and makes contact with the locking link in order to detect variation of the rotational position of the locking link.

More preferably, the ECU receives a door-close signal from the door switch when the sliding door is in a door-open keeping state, the ECU releases the door-open state keeping unit by operating the driving means if the door-open state keeping unit is in the locking state, and the ECU operates the driving source to close the sliding door.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a sliding door with an opening and closing system according to the present invention;

FIG. 2 is a view showing an opening and closing system for a power sliding door according to one embodiment of the present invention;

FIG. 3 is a front view of a locking controller provided in an opening and closing system of a power sliding door according to one embodiment of the present invention,

FIG. 4A is a perspective view of a door-open state keeping unit according to one embodiment of the present invention when the door-open state keeping unit is released;

FIG. 4B is a perspective view of a door-open state keeping unit according to one embodiment of the present invention when the door-open state keeping unit is locked, and

FIGS. 5A to 5C are views showing operational states of cables provided in an opening and closing system of a power sliding door according to one embodiment of the present invention.

### DETAILED DESCRIPTION OF THE INVENTION

Hereinafter, a preferred embodiment of the present invention will be described with reference to the accompanying drawings. In the following description and drawings, the same reference numerals are used to designate the same or similar components, and so repetition of the description on the same or similar components will be omitted .

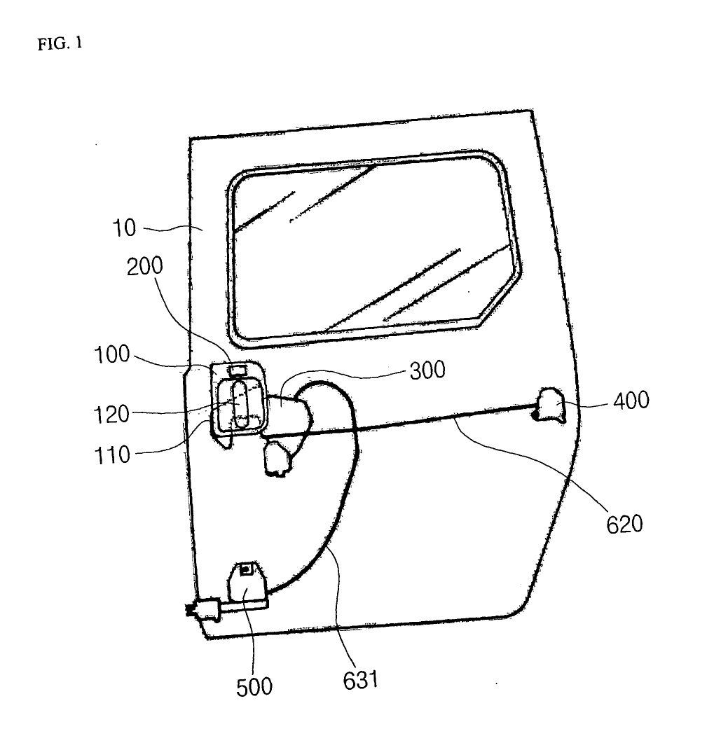

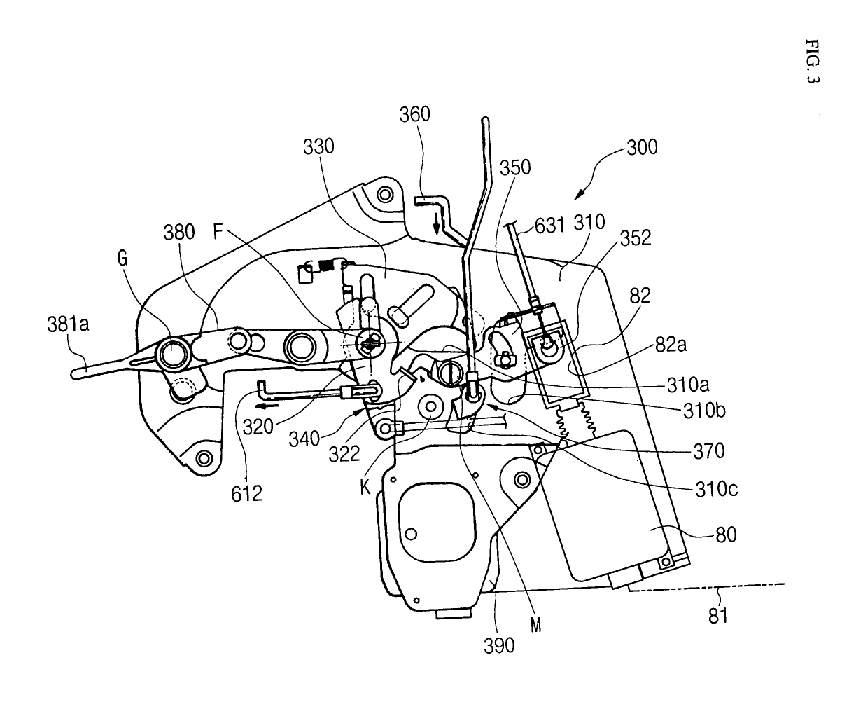

Referring to FIG. 1, door 10 includes handle assembly 100, with inner handle 120 and handle housing 110. Door locking knob 200 is also provided. Locking controller 300 includes a plurality of links installed in a housing 310 (see FIG. 3). The locking controller 300 transfers driving force of a handle to a door-closed state keeping unit 400 or a door-open state keeping unit 500 in order to control the operation of the door-closed state keeping unit 400 or the door-open state keeping unit 500. More specifically, the locking controller 300 includes a link 350 for locking or releasing the door-open state keeping unit 500 through a cable 631.

In more detail and with reference to FIG. 3, the locking controller 300 has the housing 310 provided with a plurality of coupling sections and guide holes 310a, 310b and 310c, first to third links 320, 330 and 340, which are rotated about a first hinge shaft F, and a fourth link 350 rotated about a second hinge shaft M. The first link 320 is connected to an inner handle 120, the second link 330 is used for controlling an operation of the links, the third link 340 is connected to the door-closed state keeping unit 400, and the fourth link 350 is connected to the door-open state keeping unit 500 as mentioned above.

In addition, the locking controller 300 includes a lever 360 for an outer handle, a door locking mechanism 370 rotated about a third hinge shaft K, an anti door-open mechanism 380 rotated bout a fourth hinge shaft G, and an actuator 390 for electrically controlling an operation of the door locking mechanism 370. The above components are incorporated with each other.

The locking controller 300 having the above construction is operated by the inner handle 120 and the outer handle, which are selectively moved into a door-open position or a door-close position from a neutral position by a user. Locking controller 300 is also connected to both door-closed state keeping unit 400 and door-open state keeping unit 500 by cable 631 to control the operation of the door-closed state keeping unit 400 and door-open state keeping unit 500.

The first link 320 cooperates with the inner handle 120 when the inner handle 120 is moved into the door-open position or when the inner handle 120 is moved into the door-close position so as to release a locking state of the door-closed state keeping unit 400 by operating the third link 340 through the second link 330, or so as to release a locking state of the door-open state keeping unit 500 by operating the fourth link 350.

In addition, a lever 360 cooperates with the outer handle when the outer handle is operated in order to release a locking state of the door-closed state keeping unit 400 by operating the third link 340 through the second link 330 while simultaneously releasing a locking state of the door-open state keeping unit 500 by operating the fourth link 350.

When the door-locking knob 200 is operated to lock the sliding door 10, the door locking mechanism 370 provided in the locking controller 300 cooperates with the door-locking knob 200 in order to shut off power transmission from the second link 330 to the third link 340.

In addition, the anti door-open mechanism 380 provided in the locking controller 300 cooperates with a handle section 381a so as to shut off power transmission from the first link 320 to the second link 330.

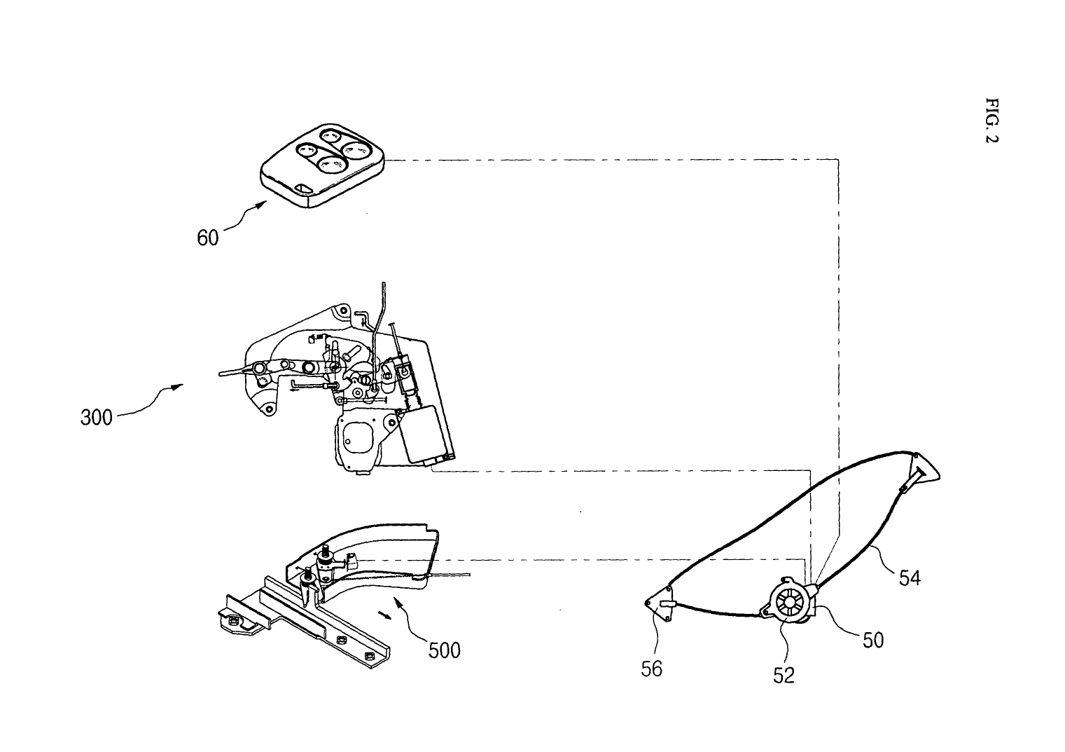

As shown in FIG. 2, a power sliding door 10 according to an embodiment of the present invention includes a motor 52, which is a driving source, a cable 54, which is a power transmission device transferring power generated from the motor 52 so as to open/close the power sliding door 10, and an ECU (electrical control unit) 50 cooperating with a door switch 60 for controlling an operation of the motor 52. The ECU 50 may comprise an appropriate processor and other hardware, software and/or firmware as may be selected and programmed by a person of ordinary skill in the art based on the teachings herein.

The motor 52 is preferably installed at a rear panel of a vehicle. The motor 52 winds or releases a cable 54 in a front direction or a rear direction according to an operation of the door switch 60 so that the sliding door 10 fixedly connected to one side of the cable 54 through a pulley 56 is driven in a door-open direction or a door-close direction

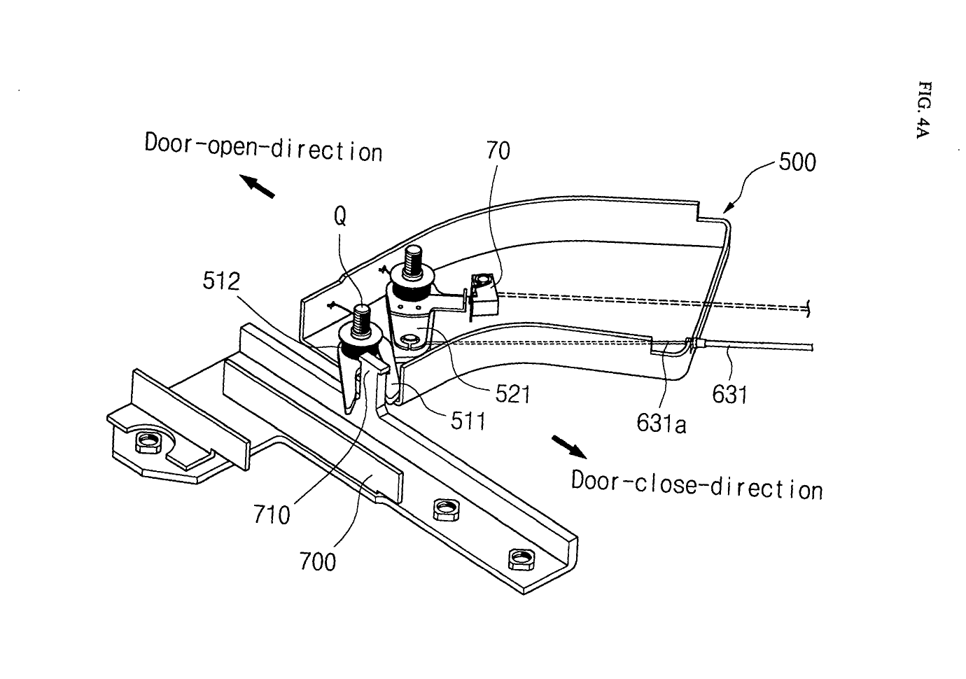

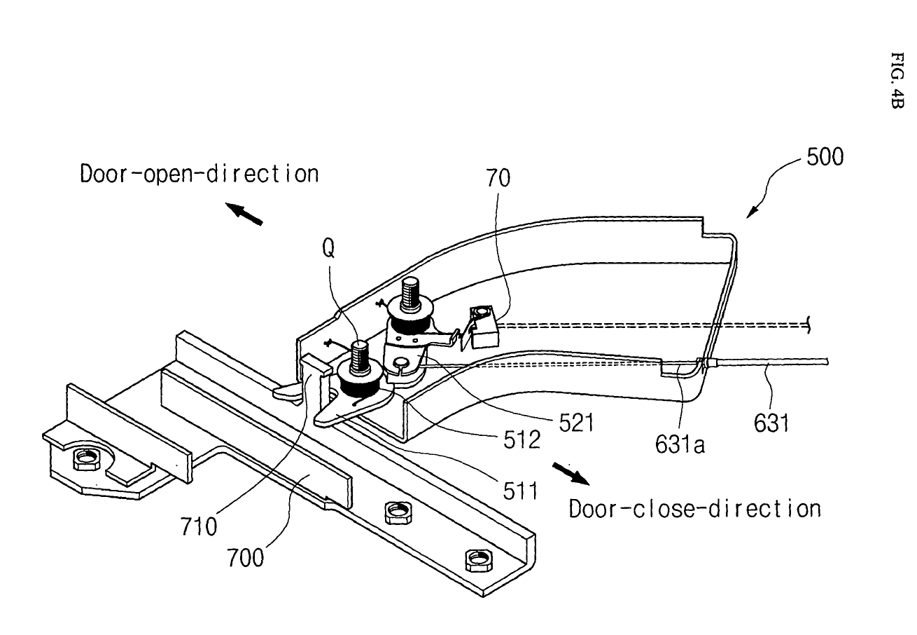

In addition, as shown in FIGS. 4A and 4B, the door-open state keeping unit 500 includes a coupling link 511 rotatably coupled with a protrusion 710 of a chassis member 700, and a locking link 521 rotatably connected to the fourth link 350 through the cable 631 in order to lock or release a coupling state between the coupling link 511 and the protrusion 710.

The door-open state keeping unit 500 is provided with a sensor for detecting locking and releasing states of the door-open state keeping unit 500.

The sensor includes a micro-switch 70, which detects the locking and releasing states of the door-open state keeping unit 500 depending on a rotational position of the locking link 521. The micro-switch 70 is installed at one side of the locking link 521 and makes contact with the locking link 521 in order to detect variation of the rotational position of the locking link 521. A driving device is provided to allow the door-open state keeping unit 500 to be switched into the locking state or releasing state by operating the fourth link 350.

The fourth link 350 is preferably rotatably fixed to the housing 310 about the second hinge shaft M and connected to the door-open state keeping unit 500 through the cable 631. In addition, the driving device is connected to one end of the fourth link 350 so as to rotate the fourth link 350 about the second hinge shaft M.

The driving device includes an actuator 80, which is electrically connected to the ECU 50 through a wire harness 81. An elongated hole 82a is formed at a driving end 82 of the actuator 80 so that a free end 352 of the second link 350 is movably inserted into the elongated hole 82a of the actuator 80.

The ECU 50 receives an operating signal from the door switch 60 to control an operation of the motor 52 for opening/closing the sliding door 10. In addition, the ECU 50 receives a detecting signal regarding the locking and releasing states of the door-open state keeping unit 500 from the micro-switch 70 to control the an operation of the actuator 80.

That is, in the door-open state, the ECU 50 receives a door-close signal from the door switch 60. The ECU 50 simultaneously receives a signal regarding locking and releasing states of the door-open state keeping unit 500 from the micro-switch 70. If the door-open state keeping unit 500 is in the locking state, the ECU 50 operates the actor 80 so as to release the door-open state keeping unit 500. Then, the ECU 50 operates the motor 52 so as to close the sliding door 10.

If the door-open state keeping unit 500 is in the releasing state, the ECU 50 does not operates the actuator 80, but only operates the motor 52 in order to close the sliding door 10.

Hereinafter, operation of the opening and closing system for the sliding door according to a preferred embodiment of the present invention will be described For the convenience of the description, a manual mode of the opening and closing system, in which the door-open state keeping unit is Bated by manually handling the inner handle will be described first.

If a passenger pulls or pushes the inner handle 120 in the door-close direction in a state that the sliding door 10 has been moved into a predetermined door-open position and engaged with the door-open state keeping unit 500, the inner handle 120 is rotated in the door-close direction about the hinge shaft so that a rod (not shown) connected to a rod connecting section (not shown) of the inner handle 120 is pushed.

Accordingly, a rod 612 of the locking controller 300 is pushed while rotating the first link 320 in a counterclockwise direction about the first hinge shaft F (referred to FIG. 3). In addition, the other front end 322 of the first link 320 pushes a front end of the fourth link so that the fourth link 350 is rotated in a clockwise direction about the second hinge shaft M.

At this time, a wire 63la of the cable 631 connected to the fourth link 350 pulled, so the locking link 521 of the door-open state keeping unit 600, which is connected to the wire 63la of the cable 631, is rotated in the counterclockwise direction, so that the coupling link 511 is released from the locking link 521, thereby allowing the sliding door 10 to move in the door-close direction.

When the sliding door 10 has been moved in the door-close direction, the coupling link 511 engaged with the protrusion 710 of the chassis member 700 is moved in the door-open direction while rotating the counterclockwise direction about a rotating shaft Q (referred to FIG. 4a). In this state, the coupling link 511 elastically supported by a torsion spring so that the coupling link 511 maintains a standby state for coupling with the locking link 521.

When the sliding door 10 reaches a door-close position, the door-closed state keeping unit 400 is engaged with the sliding door 10, so the sliding door 10 maintains in the door-closed state.

Hereinafter, an operation of the opening and closing system of the power sliding door in a power mode by using a door switch will be described. The functions and operations identical to those of the above-described manual mode will be omitted to avoid redundancy.

If a passenger closes the sliding door 10 by operating the door switch 60 in a wire/wireless manner in a state that the sliding door 10 has been moved into a predetermined door-open position and engaged with the door-open state keeping unit 500, the micro-switch 70 detecting the position of the locking link 521 by making contact with the locking link 521 transmits a signal regarding the locking or releasing state of the door-open state keeping unit 500 to the ECU 50.

The micro-switch 70 is operated as shown in FIGS. 4A and 4B. When the door-open state keeping unit 500 is in the releasing state, the micro-switch 70 is grounded by the locking link 521 as shown in FIG. 4A . If the door-open state keeping unit 500 is in the locking state, the micro-switch 70 is separated from the locking link 521 so that the micro-switch 70 in not grounded as shown in FIG. 4B. The micro-switch 70 sends an electrical signal to the ECU 50 corresponding to the grounding state thereof

Upon receiving the signal representing the locking state of the door-open state keeping unit 500 from the micro-switch 70, the ECU 50 transmits an electric signal to the actuator 80 to operate the actuator 80 such that the driving end 82 of the actuator 80 is moved down.

Such an action of the actuator 80 causes the second link 350 to rotate in the clockwise direction about the second hinge shaft M, so the free end 352 of the second link 350 moves down. Then, the wire 631 of the cable 631 connected to the fourth link 350 is pulled so that the locking link 521 of the door-open state keeping unit 500 is released in the same manner as described above.

It is preferred to continuously operate the actuator 80 for 2 to 3 seconds in order to prevent the locking link 521 from being rotated into a locking position before the power sliding door system is operated.

Then, the ECU 50 operates the motor 52 of the power sliding door system so that the sliding door 10 is moved into the door-close direction. When the sliding door 10 reaches the door-close position, the door-closed state keeping unit 400 is engaged with the sliding door 10, so that the sliding door 10 is maintained in the door-closed state.

As mentioned above, the driving end 82 of the actuator 80 is formed with the elongated hole 82a, into which the fourth link 350 is movably inserted.

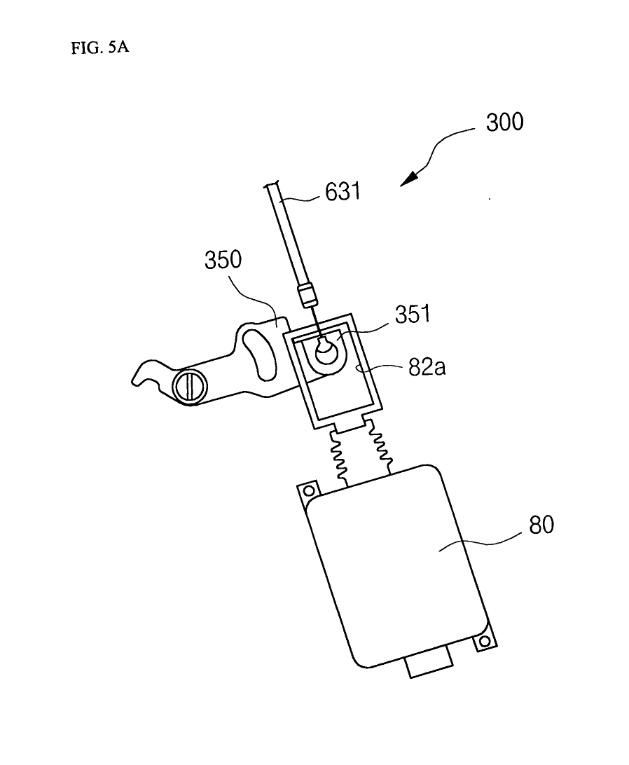

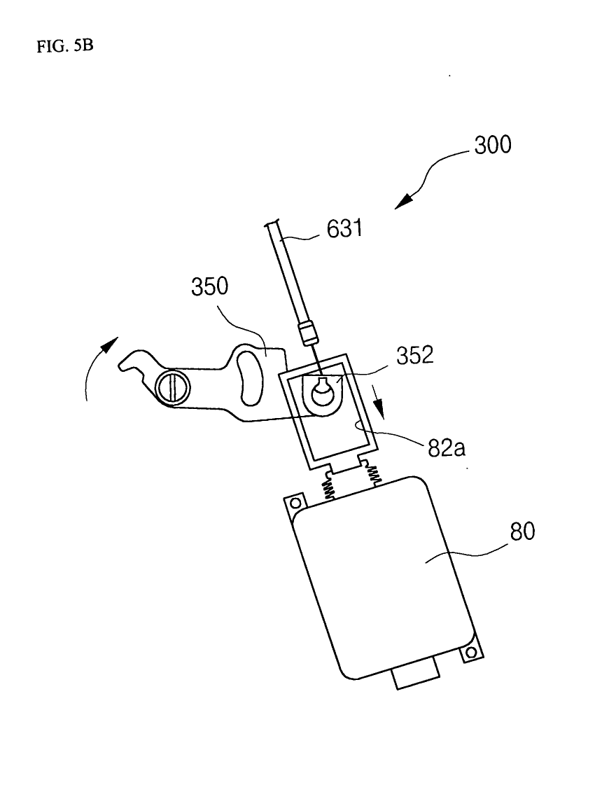

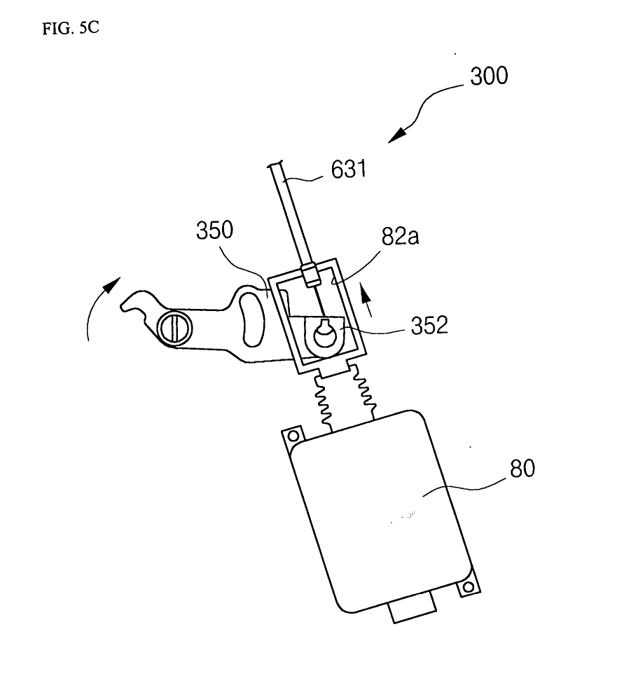

The above structure allows the fourth link 350 to be operated corresponding to the operation of the actuator 80, as shown in FIGS. 5A and 5b, in the power mode using the door switch 60, and allows the fourth link 350 to be freely rotated in the elongated hole 82a when the actuator 80 is not operated, as shown in FIG. 5C, in the manual mode using the inner handle.

Although a preferred embodiment of the present invention has been described for illustrative purposes, those skilled in the art will appreciate that various modifications, additions and substitutions are possible, without departing from the scope and spirit of the invention as disclosed in the accompanying claims.

That is, the closing and opening system for the sliding door according to the present invention is not limited to the power sliding door operated by means of the motor and cable. The present invention includes various kinds of driving sources controlled by the ECU.

In addition, the closing and opening system for the sliding door according to the present invention is not limited to the locking controller and the door-open state keeping unit having the above-mentioned structure. That is, the present invention includes various kinds of modified locking controllers and the actuator can be connected to a device having a function similar to a function of the fourth link. In addition, the micro-switch can be installed in a proper position of the door-open state keeping unit even if the structure of the door-open state keeping unit is modified.

Furthermore, besides the actuator, which operates the fourth link by receiving a control signal from the ECU, another driving sources such as motors provided with intermediate members (for example, gears) can be used in the present invention.

In addition, various kinds of sensors or switches can be used instead of the above-described sensor if they can transmit a detecting signal to the ECU by sensing a rotational position of the locking link.

The opening and closing system for the sliding door according to the present invention can be stably installed in the vehicle equipped with the sliding door having the door-open state keeping unit and can be safely operate.

What is claimed is:

1. An opening and closing system for a power sliding door comprising:
a locking controller alternately transferring driving force of a handle to a door-closed state keeping unit and a door-open state keeping unit in order to control operation of the door-closed state keeping unit or door-open state keeping unit, said controller having a link for locking or releasing the door-open state keeping unit through a cable;
a means for detecting locking and releasing states of the door-open state keeping unit;
a driving means for switching the door-open state keeping unit into the locking state or the releasing state by operating the link; and
an ECU controlling a driving source, which opens or closes the sliding door, by receiving a signal from a door switch and controlling operation of the driving means by receiving a detecting signal regarding the locking state and the releasing state of the door-open state keeping unit from the detecting means.

2. The opening and closing system for a power sliding door as claimed in claim 1, wherein the link is rotatably fixed to the housing about a hinge shaft and connected to the door-open state keeping unit through a cable, and the driving means is connected to one end of the link so as to rotate the link about the hinge shaft.

3. The opening and closing system for a power sliding door as claimed in claim 2, wherein the driving means is an actuator having a driving end formed with an elongated hole, into which a free end of the link is movably inserted.

4. The opening and closing system for a power sliding door as claimed in claim 1, wherein the door-open state keeping unit includes a coupling link rotatably coupled with a protrusion of a chassis member, and a locking link rotatably connected to the link through the cable in order to lock or release a coupling state between the coupling link and the protrusion, and the detecting means detects the locking and releasing states of the door-open state keeping unit depending on a rotational position of the locking link.

5. The opening and closing system for a power sliding door as claimed in claim 4, wherein the detecting means is a micro-switch, which is installed at one side of the locking link and makes contact with the locking link in order to detect variation of the rotational position of the locking link.

6. The opening and closing system for a power sliding door as claimed in claim 1, wherein the ECU receives a door-close signal from the door switch when the sliding door is in a door-open keeping state, the ECU releases the door-open state keeping unit by operating the driving means if the door-open state keeping unit is in the locking state, and the ECU operates the driving source to close the sliding door.
